(19) United States
(12) Patent Application Publication
(10) Pub. No.: US 2001/0004759 A1
(43) Pub. Date: Jun. 21, 2001

(54) Method and system for approving a password

(76) Inventor: Osmonen Heikki, Helsinki (FI)

Correspondence Address: Michael B. Lasky, Altera Law Group, Suite 100, 6500 City West Parkway, Minneapolis, MN, 55344-7701, US

(21) Appl. No.: 09/777,752

(22) Filed: Feb. 5, 2001

Related U.S. Application Data
(63) Continuation of application No. PCT/FI99/00693, filed on Aug. 23, 1999.

(30) Foreign Application Priority Data
Aug. 25, 1998 (FI) 981819

(51) Int. Cl. H04L 9/32

(52) U.S. Cl. 713/202; 713/183

(57) ABSTRACT

Method and system for approving a password corresponding to a user identifier in a user identification system in which the user identifier is associated with a user profile and in which the password consists of characters comprised in a total range of characters. According to the invention, a data item indicating whether the password should contain a character belonging to a predefined subset in the total range of characters is added to the user profile.

### FIELD OF THE INVENTION

The present invention concerns a method as defined in the preamble of claim 1 and a system as defined in the preamble of claim 5 for approving a password.

### BACKGROUND OF THE INVENTION

It is a generally known practice to use a user identifier and a corresponding password as a key to accessing information systems. This improves the safety of information systems and prevents information from being accessed by parties for which it is not intended. A password is a given string which is used to identify a user who logs in to a system by giving his/her user identifier.

The person maintaining the information system may make a definition in the user identification system requiring that special characters be included in all passwords. Special characters are symbols not included in the basic alphabet. The use of special characters further improves data security because the larger the choice of characters for a password, the larger will be the number of character combinations to try and the more difficult will it be to break up the password.

In certain MMI systems (MMI, Man Machine Interface), a separate user profile is created for each user. The user profile defines e.g. which MML commands the user is authorised to execute, and it is associated with the user name. When the user issues a command, the system checks whether the session in question has the authority to execute that command.

In the above-mentioned user identification system, a problem is that the use of special characters in a password is either optional or obligatory for all users. However, in many information systems, it would be important to require of certain users that they use longer passwords including special characters. Such passwords are more difficult to break up. At present, it is not possible for a person maintaining a user identification system to define which users are required to include more special characters in their passwords than others.

The object of the present invention is to eliminate the drawbacks described above or at least to significantly alleviate them.

A specific object of the present invention is to disclose a new type of method and system for approval of a password corresponding to a user identifier.

### BRIEF DESCRIPTION OF THE INVENTION

In the method of the present invention for approving a password in a user identification system, in which the user identifier is associated with a user profile, a definition is made for each user profile, specifying whether the password should include special characters. Special characters are characters belonging to a predefined subset in a total range of characters, which includes all available characters. According to the invention, data indicating whether the password should include a character belonging to a predefined subset of the total range of characters is added to the user profile.

In an embodiment of the method, data indicating the minimum number of characters belonging to a predefined subset in the total range of characters is added to the user profile. In this case, the user must use a password containing at least the minimum number of special characters. The number of special characters is preferably verified in the user identification system.

In an embodiment of the method, when a user changes his/her password, a check is performed before approval of the new password to verify whether the password contains at least the required number of characters belonging to a predefined subset in the total range of characters.

The system of the invention for approving a password in a user identification system in which a user identifier is associated with a user profile comprises an information system which a user can only access if the user identification system approves the user on the basis of the user identifier and password.

According to the invention, the user identification system comprises means for adding to the user profile a data item indicating the presence in the password of a character belonging to a predefined subset in a total range of characters. The total range of characters comprises all the available characters.

In an embodiment of the system, the user identification system comprises means for adding to the user profile a data item indicating a required minimum number of characters belonging to a predefined subset in the total range of characters. Means for comparing and verifying the number of characters belonging to a predefined subset in the total range of characters that are present in the password and the number of characters required in the user profile are preferably comprised in the user identification system.

Further, the system preferably also comprises means for checking the password to verify whether it contains the required number of characters belonging to a predefined subset in the total range of characters before a new password is approved when the password is to be changed.

The invention improves the data security of a MMl system for those users whose user profile includes a setting requiring the use of many special characters. At the same time, for users who are only entitled to execute MMl language commands of the lowest levels, a user profile can be set that does not require the use of special characters. This makes the password easier to remember and allows easier and faster access to the system.

The invention gives the person maintaining the user identification system a chance to decide which ones of the users are required to use special characters in their passwords and which ones are not.

### LIST OF ILLUSTRATIONS

In the following, the invention will be described in detail by the aid of a few examples of its embodiments, wherein

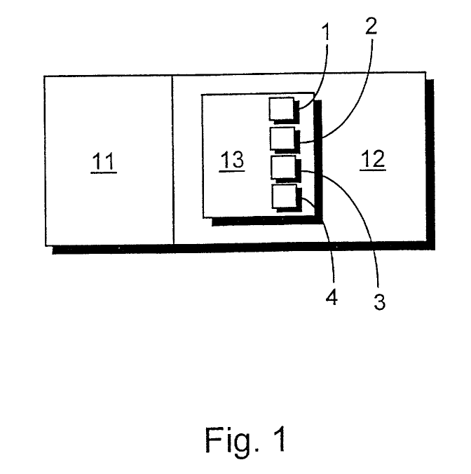

FIG. 1 presents an embodiment of the system of the invention, and

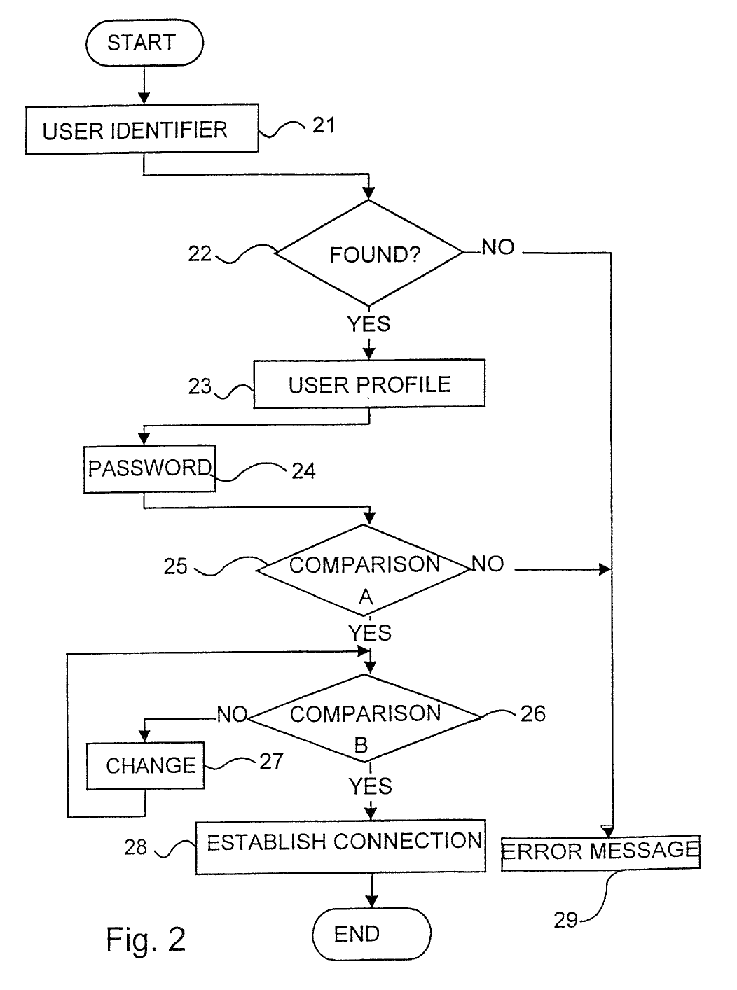

FIG. 2 presents a block diagram illustrating the operation of the embodiment according to FIG. 1.

### DETAILED DESCRIPTION OF THE INVENTION

The system illustrated in FIG. 1 comprises a user interface 11 serving as a means of controlling an information system 12. The user of the user interface must have the authority to access the information system. This authority is checked in a user identification system 13, where the user is asked to give a user identifier and a password. A preferred system for the embodiment in this example is the Nokia DX 200 telephone switching system, which has an MMl user interface and uses commands that are entered in the MMl language. These means 11, 12, 13 are implemented in a manner known in itself and they will therefore not be described here in greater detail.

The user identification system 13 comprises means 1 for adding to the user profile a data item indicating a character belonging to a predefined subset in the total range of characters. A data item indicating a minimum number of characters belonging to a predefined subset in the total range of characters is added to the user profile using means 2. Moreover, the user identification system comprises means 3 for modifying the user profile when the password is changed and means 4 for finding the required number of characters belonging to a predefined subset in the total range of characters before the password is approved. In the case of the example, these means 1, 2, 3, 4 are implemented via software.

In the following, the events in the example will be described step by step with reference to the operational block diagram in FIG. 2.

The user is asked to give a user identifier, which he/she enters via the user interface 11, block 21. The user identification system 13 verifies whether the user identifier entered has been stored in the user identification system, block 22. If the user identifier entered is unknown, then the procedure will go on to block 29, where the user is presented an error message and user identification is terminated. If the user identifier is found, then the procedure will be continued.

The user identification system 13 identifies the user profile by the user identifier and retrieves the stored information corresponding to the user profile, block 23. Based on this information, the user identification system knows the password corresponding to the user identifier, the length of the password and the minimum number of characters belonging to a predefined subset in the total range of characters that the password should contain. This subset comprises e.g. numeric characters or all special characters. In the case of the example, the subset consists of all the characters defined in the ITU-T (ITU-T, International Telecommunications Union—Telecommunications) standard IA5 (IA5, International Alphabet no. 5), in the following ranges: 21H-40H, 5BH-60H and 7BH-7EH.

Further, the user is asked to enter the password corresponding to the user identifier supplied via the user interface 11. The user enters the password, block 24, whereupon the user identification system 13 checks the properties of the password, block 25. If the password entered differs from the password corresponding to the user identifier, i.e. from the one stored in the user identification system, then the user is given an error message and the identification process is terminated, block 29. Alternatively, the user may be given a few more chances to enter the password before the identification process is ended. If the password is correct, then the system checks whether the number of special characters in the password is as required in the user profile, block 26.

If the password does not contain the required minimum number of special characters, then the user will be asked to change the password so as to give it an acceptable form, block 27. After the user has changed his/her password, it will be checked again, block 26.

If the password meets the requirements imposed by the user identification system and the user profile, then a direct connection between the user interface 11 and the information system 12 will be set up from the user identification system 13, block 28. After this, the user identification system will not necessarily interfere with the connection in any way. However, e.g. the user's authority to execute certain MMl commands may depend on the user profile.

In a system as presented in the example, a change of password can also be implemented in a way differing from the procedure presented in the example. For instance, the password characteristics required by the user profile may only be checked when the password is changed, in which case the user can retain his/her old password even if it does not meet the requirements imposed by the user profile, until he/she decides to change the passwords him/herself.

The invention is not restricted to the examples of its embodiments described above, but many variations are possible within the scope of the inventive idea defined in the claims.

1. Method for approving a password corresponding to a user identifier in a user identification system in which the user identifier is associated with a user profile and the password consists of characters comprised in a total range of characters, characterised in that a data item indicating whether the password should contain a character belonging to a predefined subset in the total range of characters is added to the user profile.

2. Method as defined in claim 1, characterised in that a data item indicating a minimum number of characters belonging to a predefined subset in the total range of characters that are to be included in the password is added to the user profile.

3. Method as defined in claim 1 or 2, characterised in that a check is performed in the user identification system to verify whether the number of characters belonging to a predefined subset in the total range of characters that are included in the password is as required in the user profile.

4. Method as defined in any one of claims 1-3, characterised in that, when a password is being changed, a check is performed before approval of the new password to verify the number of characters in the password that belong to a predefined subset in the total range of characters.

5. System for approving a password corresponding to a user identifier in a user identification system in which the user identifier is associated with a user profile and in which the password consists of characters comprised in a total range of characters, characterised in that the user identification system comprises means (1) for adding to the user profile a data item indicating the presence in the password of a character belonging to a predefined subset in the total range of characters.

6. System as defined in claim 5, characterised in that the user identification system comprises means (2) for adding to the user profile a data item indicating a minimum number of characters belonging to a predefined subset in the total range of characters that should be included in the password.

7. System as defined in claim 5 or 6, characterised in that the user identification system comprises means (3) for comparing and verifying the number of characters in the password that belong to a predefined subset in the total range of characters and the number of characters required in the user profile.

8. System as defined in any one of claims 5-7, characterised in that the user identification system comprises means (4) for checking the password to verify the number of characters belonging to a predefined subset in the total range of characters when a password is being changed, before the new password is approved.
